(19) United States
(12) Patent Application Publication
(10) Pub. No.: US 2006/0080063 A1
(43) Pub. Date: Apr. 13, 2006

(54) Systems and methods for externally monitoring equipment use

(75) Inventor: Thomas H. Vaughn, Springfield, IL (US)

Correspondence Address: Attorney, Intellectual Property;Honeywell International, Inc., 101 Columbia Rd., P.O. Box 2245, Morristown, NJ, 07962, US

(73) Assignee: Honeywell International, Inc.

(21) Appl. No.: 10/850,853

(22) Filed: May 21, 2004

Related U.S. Application Data
(60) Provisional application No. 60/472,818, filed on May 22, 2003.

(51) Int. Cl. G06F 17/40

(52) U.S. Cl. 702/187

(57) ABSTRACT

Systems and methods that can externally meter and display cumulative, noncumulative, and re-settable service hours for monitored equipment as well as provide data associated with incremental amounts of equipment usage (e.g., hours, days, etc.). System external interfaces with metered equipment to determine usage. Systems and methods of use for recording the total units of cumulative, incremental and re-settable use of equipment, such as publicly available electromechanical equipment rentals (e.g., carpet cleaners, lawn maintenance equipment, electrical generators, and audio/visual equipment. Equipment-mounted meter can performs as a data recorder for tracking metered equipment usage. A monitoring unit associated with metered equipment can be battery powered and self contained. A handheld device is adaptable to communicate with, interrogate and reset functions for metered equipment.

### CROSS-REFERENCE TO RELATED APPLICATION FIELD OF THE INVENTION

This patent application claims priority under 35 U.S.C. §119(e) to provisional patent application Ser. No. 60/472,818, entitled “Systems and Methods for Externally Monitoring Equipment Use,” which was filed May 22, 2003, the disclosure of which is incorporated herein by reference.

### FIELD OF THE INVENTION

The present invention is generally related to equipment metering/monitoring systems and methods. More particularly, the present invention relates to a system and method that can monitor and display cumulative and noncumulative, resettable service hours for equipment as well as providing data associated with incremental amounts of equipment usage (e.g., hours, days, etc.). Furthermore, the present invention relates to systems and methods for externally interfacing with metered equipment to determine usage.

### BACKGROUND

Metering devices have generally been used to monitor the ongoing duration that equipment has been in use. For example, hour meters are known to be used to monitor the total number of hours that an airplane, tractor or generator has been in use, similar to how an odometer keep track of the number of miles or kilometers that a automobile has been driven.

Although larger, generally considered expensive, mechanical equipment has been effectively monitored in the past, monitoring has typically been limited to mechanical function (e.g., miles driven or hours of mechanical functioning. Smaller equipment, such as consumer electromechanical equipment rentals (e.g., carpet cleaners) have not been provided with meters or monitoring equipment for tracking overall and incremental usage. Like larger equipment, maintenance schedules and salvage considerations are typically managed for un-metered equipment, such as carpet cleaners. True or more accurate usage information, however, is not possible where only written records (e.g., rental records) are kept for un-metered equipment.

The present inventor has recognized that it would be useful if system and methods providing usage monitoring capabilities for all eletromechanical equipment that would enable equipment managers to more effectively plan maintenance and replacement/salvage activities for previously un-monitored equipment such as rentable carpet cleaners, and also provide methods and systems for managing data.

### SUMMARY OF THE INVENTION

The following summary of the invention is provided to facilitate an understanding of some of the innovative features unique to the present invention and is not intended to be a full description. A full appreciation of the various aspects of the invention can only be gained after considering the entire specification, claims, drawings and abstract as a whole.

In accordance with features and preferred embodiments, systems and methods are described that permit the recording and monitoring of cumulative as well as incremental usage (e.g., incremental and resettable service periods associated with equipment rental periods) for equipment. Usage of metered equipment can be measured as units including hours, days, weeks, months, etc. Service periods can be determined for equipment based on usage data defined by time between specified units of use in a maintenance schedule.

It is a feature of the present invention to provide an equipment-mounted meter that performs as a data recorder for tracking metered equipment usage.

It is another feature of the present invention to provide a handheld device that can be adapted to permit communication with, interrogation of, and reset functions for metered equipment.

A monitoring unit associated with metered equipment can be battery powered and self contained, although it can also be powered from the metered equipment being monitored, at least part of the time.

The handheld device could be as simple as a permanent magnet, or as complicated as a microcontroller with a keypad interface and including an electromagnet for coupling with the monitoring unit.

A hall effect sensor will be mounted next to a 2 terminal current shunt (or wire) which would sense the presence of AC or DC current to the equipment being monitored as well as sense the presence of a AC or DC magnetic field from a handheld device used by service personnel to read the various records and reset them as desired.

The present invention can be used for eletromechanical equipment monitoring applications, such as industrial equipment maintenance meters and consumer rental equipment monitors.

### DESCRIPTION OF THE DRAWINGS

The accompanying figures, in which like reference numerals refer to identical or functionally-similar elements throughout separate views and which are incorporated in and form part of the specification, further illustrate the present invention and together with the detailed description of the invention serve to explain the principles of the present invention.

FIG. 1 illustrates a basic system in accordance with preferred embodiments of the present invention;

FIG. 2 illustrates additional aspects for a basic system in accordance with preferred embodiments of the present invention; and

FIG. 3 illustrates aspects for providing power to a basic system in accordance with preferred embodiments of the present invention.

### DESCRIPTION OF PREFERRED EMBODIMENTS

A device will now be described that can record the total units of cumulative, incremental and re-settable use of metered equipment, such as publicly available electromechanical equipment rentals (e.g., carpet cleaners, lawn maintenance equipment, electrical generators).

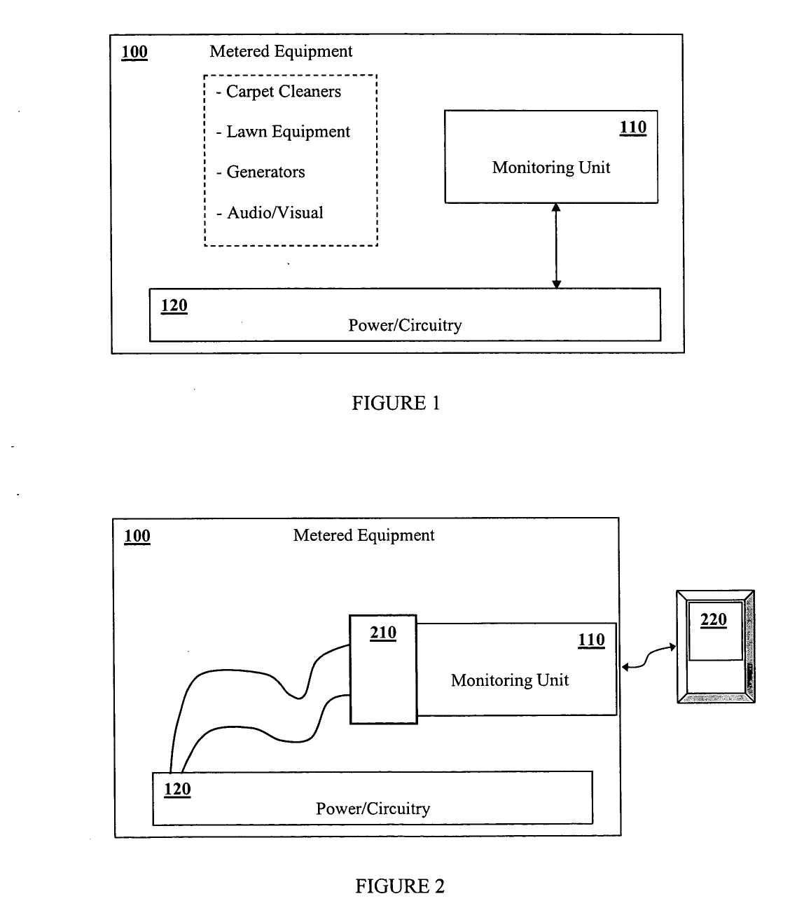

Referring to FIG. 1, a piece of metered equipment 100 is shown that includes a monitoring unit 110. The monitoring unit is adapted for placement into electrical communication with electrical power and/or power circuitry 120 associated with the metered equipment that is normally activated during any use of the metered equipment 100. The monitoring unit 110 can record and also provide data associated with the metered equipment's use. Data can be provided via a display or externally transferred from the metered equipment 100. Data can be represented as units of measurement such as minutes, hours, days, weeks, months, etc., which is further representative of the duration of interest for use of the metered equipment 100. For example “usage days” could represent a unit any 24-hour period during which the metered equipment 100 in electrically energized.

It is preferable in the United States that any system incorporating a monitoring unit will sense power systems having parameters of 120 VAC or 240 VAC, and 50 or 60 HZ, which are common power supply capabilities. It should be appreciated that although other voltages, currents and frequencies are used throughout the world, the present invention can be adapted for use with diverse power parameters.

As shown in FIG. 2, the monitoring unit 110 can include use of a Hall effect sensor 210 that can be mounted next to a two terminal current shunt (or wire) which can thereby sense the presence and/or use of either AC or DC current to/by the metered equipment 100. The Hall effect sensor 210 can also be used to sense the presence of an AC or DC magnetic field from a metering device 220 in the form of a hand held unit, which can be provided in the form of a magnetic wand adapted for use by equipment servicing personnel to read and reset metered values of interest. Hand held units are currently available in various forms and with different communication capabilities. It should be appreciated that metering device 220 can be provided in form factors suitable for diverse application and can be adapted for communication with monitoring units 110 via magnetic, direct electrical interface, wireless and optical means known in the art.

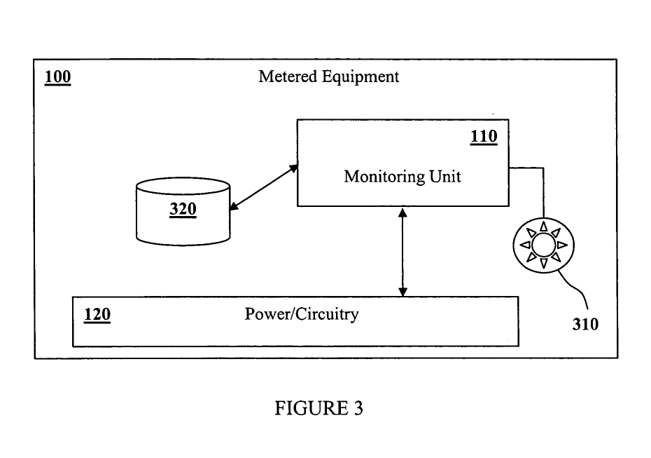

Referring to FIG. 3, monitoring unit 110 can include a power supply 310 wherein power can be derived from a magnetic field induced by the equipment's AC current/power circuitry 120 and can furthermore be used to recharge a rechargeable battery (not shown, but know in the art) in the monitoring unit 110. Nickel cadmium, lithium photo, and nickel metal hydride batteries can be considered as suitable power sources for monitoring unit 110 because of their ability to recharged as well as their power density. A replaceable battery should also be considered as an alternative power source to either a rechargeable battery or to a large capacity non-replaceable battery.

As an alternative to a bar magnet in the wand, it should be appreciated after reading the present description that a battery powered electromagnet with a switch can also be employed. Because the device can employ a Hall effect sensor, the wand can also radiate AC magnetic fields at one or more frequencies as well as providing DC signals. Additional signals can allow for the setting of the date and time as well as to reset values.

Referring again to FIG. 3, loss of data during battery change outs can be avoided by memory backup 320 known in the art, such as by including a capacitor to ride through the power outage or storing data in memory such as an EEPROM.

It should be appreciated by those skilled in the art given the present teaching of the invention that providing metering/monitoring to previously un-metered equipment can provide equipment managers and renters more accurate usage data, and such data can also provide a business with flexible pricing options. For example, a carpet cleaner may be rented to a customer for a 24 hour period, but the equipment manager will never know whether the customer only used the equipment for a few hours or almost continuously during the rental period. Wear and tear on the unit cannot be accurately determined without the benefit of monitoring/metering. Furthermore, flexible business models can now be developed for typically un-metered equipment if substantially accurate usage data can be determined. For example, a flat rate could be charged to a customer for renting equipment, but a discount could be provided if use is determined to be minor in duration. Also, a customer could be charged for equipment usage based on metered usage, rather than a flat rate. Metered usage data could be used to charge customers a more realistic and equitable rate for the rented equipment.

Regardless of the business model chosen for renting equipment to the consumer, all equipment managers in general can now be provided with more accurate usage data for equipment that has not been monitored or metered in the past using the present invention. Data can also be acquired from equipment with ease given the hand held data acquisition features of the present invention.

The embodiment and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered. The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

1. Equipment metering/monitoring method, comprising the steps of:
a) externally interfacing metering device with monitoring unit associated with metered equipment to determine usage history, said interfacing device having memory and a display and said monitoring unit further comprising a memory;
b) retrieving usage history information from the memory associated with the monitoring unit; and
c) storing usage history in memory associated with the metering device.

2. The method of claim 1 further comprising the step of displaying usage history on the display.

3. The method of claim 1 wherein usage history includes cumulative and noncumulative service hours.

4. The method of claim 1 wherein usage history includes resettable service hour.

5. The method of claim 1 wherein usage history includes incremental service hours.

6. The method of claim 1 wherein the monitoring unit performs as a data recorder for tracking usage of electromechanical rental equipment.

7. The method of claim 1 further comprising providing a handheld device that can be adapted to operate as the metering device and permit communication with, interrogation of, and reset functions for the metered equipment.

8. A system for recording equipment usage and associated with metered equipment, comprising:
a monitoring unit; and
a recording unit, recording the total units of metered equipment use including cumulative, incremental and re-settable use of equipment.

9. The system of claim 8, said recording unit including a memory.

10. The system of claim 8 further comprising dedicated battery power.

11. The system of claim 8 wherein a Hall effect sensor is mounted next to a 2 terminal current shunt to sense AC or DC current used by the metered equipment.

12. The system of claim 8, said system integrated for use in at least one of: a carpet cleaner, lawn maintenance equipment, electrical generator, and audio-visual equipment.

13. The system of claim 8 further comprising a handheld metering device adapted to communicate with including:
a recording unit, recording the total units of metered equipment use including cumulative, incremental and re-settable use of equipment; and
a display.

14. A system for recording metered equipment usage, comprising:
a handheld metering device adapted to communicate with monitoring units associated with metered equipment, said handheld metering device further comprising:
a recording unit, recording the total units of metered equipment use including cumulative, incremental and re-seftable use of equipment; and
a display;
wherein said handled metering device records the total units of metered equipment use including cumulative, incremental and re-settable use of equipment.

15. The system of claim 14 further comprising at least one monitoring unit associated with at least one metered device.

16. The system of claim 15, said metered device including at least one of: a carpet cleaner, lawn maintenance equipment, electrical generator, and audio-visual equipment.
